(19) United States
(12) Patent Application Publication
(10) Pub. No.: US 2010/0034980 A1
(43) Pub. Date: Feb. 11, 2010

(54) METHOD FOR REDUCING THE CURING TIME OF A PAINTING COMPOSITION

(76) Inventors: Kozo Saito, Lexington, KY (US); Rodney Andrews, Lexington, KY (US); Belal Gharaibeh, Lexington, KY (US); Wahed R. Wasel, Morehead, KY (US)

Correspondence Address: KING & SCHICKLI, PLLC, 247 NORTH BROADWAY, LEXINGTON, KY, 40507, US

(21) Appl. No.: 12/189,360

(22) Filed: Aug. 11, 2008

(51) Int. Cl. C08J 7/18; C08K 5/00

(52) U.S. Cl. 427/514; 106/499; 977/742; 977/752

(57) ABSTRACT

A painting method includes the steps of painting a work piece with a painting composition incorporating between about 0.1 and 10.0 weight percent carbon nanotubes and curing the painting composition by subjecting it to radio waves having a power of between about 30 and about 5000 W at a frequency of between about 13.56, about 27.12, or about 40.68 MHz.

### TECHNICAL FIELD AND INDUSTRIAL APPLICABILITY OF THE INVENTION

The present invention relates generally to the painting field and, more particularly to a method for reducing the curing time of a painting composition.

### BACKGROUND OF THE INVENTION

The amount of time required for a painting composition to cure is of significant importance. A reduction in curing time will increase the speed of a painting line and thereby improve overall production efficiency at a manufacturing plant. A reduction in the curing time of painted striping on a parking lot or roadway will allow the parking lot or roadway to be put back into full use in a shorter period of time. These are just two examples of the many applications where a reduction in the curing time of a paint composition achieves very desirable results. The present invention relates to a painting method that significantly reduces the curing time of a painting composition so as to provide a significant advantage in most painting applications.

### SUMMARY OF THE INVENTION

In accordance with the purposes of the present, invention as described herein, a new painting method is provided. That method comprises the steps of (a) painting a work piece with a painting composition incorporating between about 0.1 and about 10.0 weight percent carbon nanotubes and (b) curing that painting composition on the work piece by subjecting that painting composition to radio waves having a power of between about 30 and about 5000 W at a frequency of about 13.56, about 27.12 MHz or about 40.68 MHz whereby the painting composition is cured in a shorter period of time.

More specifically describing the invention, the method includes curing the painting composition on the work piece by subjecting the painting composition to radio waves having a power of about 200 W at a frequency of about 13.56 MHz. Further the method includes incorporating between about 0.1 and about 5.0 weight percent carbon nanotubes in the painting composition. These carbon nanotubes may be multiwalled carbon nanotubes (MWCNTs).

In accordance with a further aspect of the present invention, the method may include premixing the carbon nanotubes with a solvent and surfactant to form a premix. The solvent is selected from a group of solvents consisting of ketones, esters, alcohols, glycol esters, hydrocarbons, water and mixtures thereof. The surfactant is selected from a group of surfactants consisting of anionic, cationic, and non-ionic surfactant and mixtures thereof. Typically the premix includes between about 0.1 and about 10.0 weight percent carbon nanotubes, between about 0.0 and about 95.0 weight percent solvent and between about 2 to 4 times the amount of carbon nanotubes as surfactant. More typically the premix includes between about 0.1 and about 5.0 weight percent carbon nanotubes, between about 50.0 and about 95.0 weight percent solvent and between about 2 to 4 times the amounts of carbon nanotubes as surfactant.

In accordance with still another aspect of the present invention, a painting composition is provided. The painting composition comprises by weight percent about 0.0 to about 98.0 percent pigment, about 0.1 to about 10.0 percent carbon nanotubes and about 0.0 to about 95.0 percent carrier. The carrier may comprise a solvent, a surfactant, other appropriate carrier materials and mixtures thereof.

In the following description there is shown and described a preferred embodiment of this invention, simply by way of illustration of one of the modes best suited to carry out the invention. As it will be realized, the invention is capable of other different embodiments and several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention and together with the description serve to explain certain principles of the invention. In the drawings:

FIG. 1 is a schematical view of a first possible embodiment of a system for rapidly curing a paint composition in accordance with the present method; and

FIG. 2 is a second possible embodiment of a system for rapidly curing a paint composition in accordance with the method of a present invention.

### DETAILED DESCRIPTION OF THE PREFERRED EMBODIMENTS OF THE INVENTION

The painting method of the present invention comprises the steps of painting a work piece with a painting composition incorporating between about 0.1 and about 10.0 weight percent carbon nanotubes. Typically the carbon nanotubes are multiwalled carbon nanotubes (MWCNTs) having a length of between about two and about 6.5 micrometers, and a pore (inner) diameter of between 2 and about 16 nanometers, and an outer diameter of between about 16 and about 400 nanometers. The painting step is followed by the curing of the painting composition on the work piece. This is accomplished, by subjecting the painting composition to radio waves having a power of between about 30 and about 5000 W (more typically 30-400 W) and, a frequency of about 13.56, about 27.12 MHz or about 40.68 MHz whereby the painting composition is cured in a shortened period of time. More specifically, the carbon nanotubes are heated by the radio waves so as to more rapidly drive off the volatiles in the painting composition and quickly cure the paint composition. In one particularly useful embodiment of the present invention the painting composition is subjected to radio waves having a power of about 200 W at a frequency of about 13.56 MHz.

While carbon nanotube weight percentage ranges of 0.1 to about 10.0 are effective, typically between about 0.1 and about 5.0 weight percent carbon nanotubes are utilized.

In accordance with an additional aspect of the present invention, the method may include premixing the carbon nanotubes with a solvent and a surfactant to form a premix. The type of solvent utilized is determined by the type of paint into which the carbon nanotubes are to be added. Thus, for example, water is used for a water-based paint. Typically the solvent is selected from a group of solvents consisting of ketones (eg. acetone, methyl ethyl ketone, methyl n-propyl ketone, methyl isobutyl ketone, methyl isoamyl ketone, methyl n-amyl ketone, diisobutyl ketone and cyclohexanone), esters (eg. methyl acetate, ethyl acetate, isopropyl acetate, n-propyl acetate, isobutyl acetate, n-butyl acetate, n-amyl acetate), alcohols (eg. methyl alcohol, ethyl alcohol, isopropyl alcohol, n-propyl alcohol, isobutyl alcohol, n-butyl alcohol, amyl alcohol), glycol esters (eg. ethylene glycol monomethyl ether, ethylene glycol monomethyl ether acetate, ethylene glycol monoethyl ether, ethylene glycol monoethyl ether acetate, ethylene glycol monobutyl ether, ethylene glycol monobutyl ether acetate, propylene glycol monomethyl ether, propylene glycol monomethyl ether acetate), hydrocarbons (eg. lacquer diluents, toluene, VM&P naphtha, xylene, mineral spirits), water and mixtures thereof. Typically, the surfactant is selected from a group of surfactants consisting of anionic, cationic, and non-ionic surfactant. The surfactant utilized must, of course, be compatible with the paint into which the premix will be added. The premix typically includes between about 5.0 and about 50.0 weight percent carbon nanotubes, between about 50.0 and about 95.0 weight percent solvent and between about 2 to 4 times the amount of carbon nanotubes as surfactant.

It should be appreciated that the terminology of “painting composition” is to be given its broadest possible interpretation. Generally the terminology includes paints, primers and water borne coatings including but not limited to high solid paints, waterborne paints, solvent-based paints and epoxy paints. The painting composition of the present invention comprises by weight percent about 0.0 to about 98.0 percent pigment, about 0.1 to about 10.0 percent carbon nanotubes and about 0.0 to about 95.0 percent carrier. The carrier may comprise any appropriate solvent, surfactant or other material or composition known to be useful for this purpose.

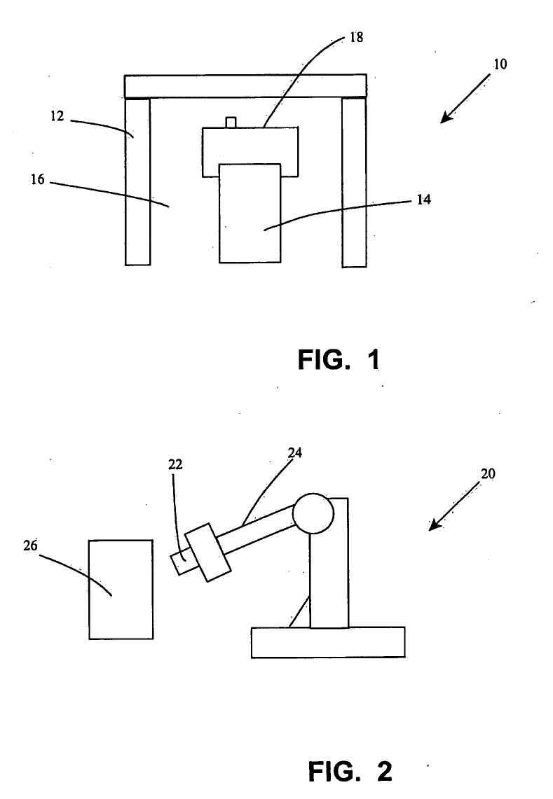

Reference is now made to FIGS. 1 and 2 schematically illustrating two possible curing systems for implementing the method of the present invention in the production line setting. As illustrated in the FIG. 1, the system 10 comprises a radio frequency field, enclosure 12 of substantially u-shape incorporating a radio frequency generator. The work piece 14, which has been previously painted with the painting composition incorporating carbon nanotubes, is moved through the interior 16 of the enclosure 12 by means of a conveyor 18. As the work piece 14 is moved through the enclosure 12, the paint composition on the work piece is subjected to radio waves that rapidly cure the paint composition.

The system 20 illustrated in FIG. 2 comprises a radio frequency generator head 22 held on the end of a robot arm 24. The robot arm 24 moves the radio frequency generator 22 back and forth just above the surface of the work piece 26 to subject the painting composition to radio waves that quickly cure the composition.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A painting method, comprising:
painting a work piece with a painting composition incorporating between about 0.1 and about 10.0 weight percent carbon nanotubes; and
curing said painting composition on said work piece by subjecting said painting composition on said work piece to radio waves having a power of between about 30 and about 5000 W at a frequency of about 13.56, about 27.12 MHz or about 40.65 MHz whereby said painting composition is cured in a shortened period of time.

2. The method of claim 1, including curing said painting composition on said work piece by subjecting said painting composition to radio waves having a power of about 200 W.

3. The method of claim 1, including curing said painting composition on said work piece by subjecting said painting composition to radio waves at a frequency of about 13.56 MHz.

4. The method of claim 1, including curing said painting composition on said work piece by subjecting said painting composition to radio waves having a power, of about 200 W at a frequency of about 13.56 MHz.

5. The method of claim 1, including incorporating between about 0.1 and about 5.0 weight percent carbon nanotubes is said painting composition.

6. The method of claim 5, wherever said carbon nanotubes are multiwalled carbon nanotubes.

7. The method of claim 1, including premixing said carbon nanotubes with a solvent, and a surfactant to form a premix.

8. The method of claim 7, including selecting said solvent from a group of solvents consisting of ketones, esters, alcohols, glycol ethers, hydrocarbons, water and mixtures thereof.

9. The method of claim 8, including selecting said surfactant from a group of surfactants consisting of anionic, cationic, and non-ionic surfactant and mixtures thereof.

10. The method of claim 9, including providing said premix with between about 5.0 and about 50.0 weight percent carbon nanotubes, between about 50.0 and about 95.0 weight percent solvent and about 2 to 4 times the amount of carbon nanotubes as surfactant.

11. A painting composition, comprising by weight percent: about 0.0 to about 98.0 percent pigment; about 0.1 to about 10.0 percent carbon nanotubes; and about 0.0 to about 95.0 percent carrier.
